(19) United States
(12) Patent Application Publication
(10) Pub. No.: US 2023/0400329 A1
(43) Pub. Date: Dec. 14, 2023

(54) MARKING LOCATION ON A DIGITAL INTERACTIVE MAP

(71) Applicant: Hoan Doan Vo, Anaheim, CA (US)

(72) Inventor: Hoang Doan Vo, Anaheim, CA (US)

(73) Assignee: InMapz Inc., Anaheim, CA (US)

(21) Appl. No.: 17/806,688

(22) Filed: Jun. 13, 2022

(51) Int. Cl. G01C 21/00; G06F 16/29; G06F 3/0488

(52) U.S. Cl. CPC G01C 21/3856; G06F 16/29; G06F 3/0488

(57) ABSTRACT

A location of an item is marked on a digital interactive map. The user of a portable electronic device with a touch sensitive display that shows a digital interactive map may touch for a finite time a spot on the map that corresponds to the location. The digital interactive map records the location of the item, its GPS coordinates, the floor of the building, and other associated meta data.

### BACKGROUND

### Technical Field

The invention generally relates to systems, methods and devices that allow for easy location marking and item representation movement on an electronic digital interactive map by one or more users.

### Background Art

In general, there is a need for digital interactive maps. Such maps may be presented on portable electronic devices such as smart phones, tablets and the like, in the form of mobile applications.

A number of electronic mapping applications are known in the art. For example, U.S. Patent Application Publication No. 20210215567 to Koo et al. describes a water leak detection system that is integrated with an indoor map. The system may be used to carry out a method for water leak detection that uses radio waves in which an antenna transmits a repeated pattern of radio waves that reflect from wet areas, antennas receive the reflected radio waves, signal analysis is done on the received radio waves to determine the location of the wet areas on an indoor map.

Similarly, other location-based tracking technologies are known in the art. For example, U.S. Pat. No. 9,310,206 to Forstall et al. describes technology in which location information is used to build a database of locations having associated audio, video, image, or text data. In some implementations, a device includes a touch-sensitive display and collects data associated with a geographic location of interest.

The utility, convenience, and popularity of mobile applications is often gated by the user interface, which not only defines how users receive content but also how users create content on their mobile devices. Therefore, the user interface is critical to the overall user experience.

Unfortunately, there are limitations associated with existing user interfaces for portable electronic devices such as smartphones and tablets. The existing user interface is optimized for content consumption as opposed to content creation. For example, a user may require three to five times as long to type text on a mobile device compared to on a keyboard of a laptop computer. Consequently, the use of mobile devices as productivity tools has been severely constrained.

Thus, there is a need for technologies that allow for improved digital interactive mapping technologies that allow for optimization associated with content creation rather than with focus on content consumption.

### SUMMARY

Provided is a method for marking and recording a location of an item on a digital interactive map. The method comprises: providing the digital interactive map on a portable electronic device with a touch-sensitive display; displaying the digital interactive map on a web browser or a mobile device app as presented on the touch sensitive display and/or some other display; and allowing a user to enter the location of the item by a point of contact for a finite amount of time on the digital interactive map, thereby recording the item and the location on the digital interactive map.

In another embodiment, a system is provided for moving a location of a representation of a real item on a three-dimensional electronic digital interactive map. The system comprises: the digital interactive map provided on a touch sensitive device display having the real item represented at a location on the map; a display means for displaying the digital interactive map as a web browser or mobile app device as presented on the touch sensitive display; and means that allow user to change the location of the item by a point of contact through touch of the display for a finite amount of time on the digital interactive map. As a result, the invention may allow for substantially instantaneous updating of a changed location of the item's representation on the digital interactive map.

In some cases, means for calculating or recalculating a path to find the changed location may be provided. Such means typically involves both hardware, e.g., silicon computer chips, and software, e.g., that which can be uploaded electronically via cyberspace or web-based means.

In a further embodiment, the invention provides a device for displaying to a user a navigation path to a representation of a real item relative to a building on a digital interactive map. The device may comprise: a web-based or mobile device app based digital interactive map provided as hardware and optional software in a handheld device that has touch sensitive display, wherein the map contains the representation of the real item at a location on the map, and the map contains information regarding a building's layout; a means for locating the user relative the representation of the item on the map; and a means for drawing a navigation path for the user on the digital interactive map to the item relative to a layout of the building

### BRIEF DESCRIPTION OF THE DRAWINGS

FIG. 1 provides a photograph of a smart device showing the invention in use with an interface that depicts locations of places on an digital interactive map.

FIG. 2 depicts a flow chart illustrating the general workings of an embodiment of the invention.

### DETAILED DESCRIPTION

Before describing various embodiments of the present invention in detail, it is to be understood that the invention is not limited to specific electronic platforms or operating system as such may vary. It is also to be understood that the terminology used herein is for the purpose of describing particular embodiments only and is not intended to be limiting.

In addition, as used in this specification and the appended claims, the singular article forms “a,” “an,” and “the” include both singular and plural referents unless the context clearly dictates otherwise. Thus, for example, reference to “a system” refers to a single system as well as a plurality or combination of systems, reference to “a user” includes one or more users, and the like.

Furthermore, terminology indicative or suggestive of a particular spatial relationship between elements of the invention is to be construed in a relative sense rather an absolute sense unless the context of usage clearly dictates to the contrary. For example, the terms “over” and “on” as used to describe the spatial orientation of a first item relative to a second item does not necessarily indicate that the first item is located above the second item. Thus, in an electric junction box that is placed on or over a thermostat may be located above, at the same level as, or below the thermostat depending on the how the box and thermostat's description is provided from an orientational perspective. Similarly, an “upper” surface of a smart device may lie above, at the same level as, or below other portions of the device depending on the orientation of the device, unless the context of such terminology use relates to terrestrial items such as a building having a plurality of floors, in which as “upper” floors must be located above “lower” floors.

The term “app” as in “mobile app device” or as in “mobile device app,” is used in its ordinary sense and refers to an application, especially as downloaded (and installed) by a user to a mobile device.

The term “approximately” is used herein in its ordinary sense and refers to describe used to show that something is almost, but not completely, accurate or exact, in an economic, industrial, scientific, real (as in real estate) or similar sense. In some instances, the teems “about” and “roughly” can be used in place of “approximately.”

The term “digital” is used in its ordinary sense and refer to items that involve or relate to the use of computer technology. When used to describe signals or data, the term pertains to signals or data expressed as series of the digits 0 and 1, typically represented by values of a physical quantity such as voltage or magnetic polarization. The term “digital” may be contrasted with the term “analog,” though digital devices may include analog components in some instances.

The term “dimensional” as in “three-dimensional” is used herein in its ordinary mapping sense and refers to items whose location may be described with least three descriptors or coordinates, such as x, y, and z relative to an origin, or length, depth, and height dimensions relative to a reference point as is the case for polar coordinates. Thus, three-dimensional mapping may use, e.g., cartesian, radian, and/or variant systems of coordinates such as longitude, latitude, and distance relative to Earth's surface, e.g., a building's floor level, to describe a particular location within the map.

The terms “ease” and “easy” (as in easy marking) by are used herein in their ordinary sense and refer to an absence of difficulty in execution of an action referred thereto. Typically, very little training is needed to carry out such actions as the act of marking.

The terms “electronic,” “electronically,” and the like are used in their ordinary sense and relate to structures, e.g., semiconductor microstructures, that provide controlled conduction of electrons, holes or other charge carriers.

The term “floor elevation” is typically referred to as an elevation location of a building. If the term is used to refer to outside space, then the term “floor” may refer to “ground level.”

The term “frequency” is used herein in its ordinary sense and refers to the number of occurrences within a given time period. The term “frequency” does not necessarily imply regular occurrences within the given time period. For example, the term “election frequency” refers to the number of occurrences of elections held within a given time period, regardless whether the elections occur at constant or variable intervals.

The terms “GPS” or “global positioning system” refer to a system that may be at least partly based on an array of orbiting satellites that allows an accurate worldwide navigational and surveying facility based on the reception of signals from the array.

The term “icon” is used in its ordinary computing sense and refers to a symbol or graphic representation on a screen of a program, option, or window, especially one of several for selection.

The term “interactive” is used in its ordinary sense and refers to situations in which two- or multiple-way flow of information between a computer and a computer user in response to the same or different user's input.

The term “internet” is used herein in its ordinary sense and refers to an interconnected system of networks that connects computers around the world via the TCP/IP and/or other protocols. Unless the context of its usage clearly indicates otherwise, the term “web” is generally used in a synonymous manner with the term “internet.”

The terms “map” and “mapping” are used herein in their ordinary sense and refer to a diagrammatic representation of an area of land, sea, or space showing physical features such as cities, roads, buildings, floors, rooms, cubical, etc.

The term “optional” and “optionally” are used in their ordinary sense and refer to events or items that may or may not be present.

The teen “real” as in a “real item” is used in its ordinary sense and refers to something that actually exist as a thing as opposed to something imagined, supposed, and/or virtual.

The term “smart” as in “smart device” is used in its ordinary sense and refers to devices that may be programmed so as to be capable of some independent action, e.g., in response to some stimulus, such as that entered via a keyboard or a touch screen programmed so as to be capable of some independent action, e.g., by finger, mouse, stylus, etc. In some instances, a smart device may be employed in context-awareness system as a component that is able to gather information about its environment at any given time and adapt behaviors accordingly. Examples of smart devices include, for example, handheld equipment such as wireless cellphones, tablets, and other equipment that allows for wireless inductive charging of their rechargeable nonaqueous or optionally lithium-ion batteries and/or packs that may be integrated with the smart devices or easily removal therefrom for replacement.

Similarly, the term “smart” may also refer to devices that employ sensors. Thus, the invention may employ smart sensors that collects and transmit data, e.g., like temperature sensors. Such sensors may be remote from handheld equipment and may communicate with such equipment via wireless signals.

The term “substantially instantaneous” is used to refer to one or more events that to a considerable degree occur or are completed with no delay, but that the absolute absence of any delay is not required. Thus, for web-based versions of the invention, substantial instantaneous updating of locations markings from a smart device to a remote server storing a copy of an interactive map may occur within less than about 10 seconds, preferably within less than 5 second, and optimally within less than 1 or 0.5 seconds. The terms “substantial” and “substantially” are used analogously in other contexts involve an analogous definition.

The term “wayfinding” is used here to refer to a process or activity of ascertaining one's position and planning and following a route, e.g., associated with a building.

The term “Wi-Fi” refers to a facility allowing computers, smartphones, or other devices to connect to the internet or communicate with one another wirelessly within a particular area.

Thus, the invention typically provides a means for marking and recording a location of an item on a digital interactive map in conjunction with portable electronic devices, e.g., of less than approximately 1 or 2 kilograms, that may be chargeable so that they do not require electrical cords when in use, indoors or outdoors. Typically, a touch sensitive display is used to displaying the digital interactive map, e.g., via a web browser or some type of dedicated application for the portable electronic device. A user may enter the location of the item by a point of contact for a finite amount of time on the digital interactive map, which is typically displayed graphically on the display. As a result, the item's location is recorded on the digital interactive map.

When the invention is carried out in the context of real estate and/or building management, a user may mark the location of an item such as heating, ventilation, air conditioning equipment by touching a spot on a digital interactive map for a short finite time. In response to the touch, the software application shows an icon at the spot to indicate the item. In addition, the software application finds the GPS coordinates of the location and assigns them to the item. Other properties may also be included such as the wayfinding to the location, photographs of the item at that location, the serial number of the item, audio commentary about the item, and so forth.

In other embodiments, an existing item already located on a digital interactive map can be moved from one location to another location by touching the icon for a short finite time and then dragging the icon to its new location.

In yet another embodiment, a navigation path can be drawn on the digital interactive map by touching the starting location for a short finite time and moving the point of contact along the desired path. When the end of the path is reached, the touch is removed.

In another embodiment, the digital interactive map is three-dimensional. Thus, different floors of a building may be, optionally simultaneously, represented on the map.

Thus, the following items may selectively be included in system embodiments of the invention: a mobile device with one or more sensors effective to work with GPS, Wi-Fi, Bluetooth, and other location-based coordinates; mobile applications showing digital maps; web browser interface showing digital maps. Care must be taken to ensure user friendliness and ease associated. For example, when the invention is to be used with facilities managers without much technical training, color coding may be used to group actions with like functionality.

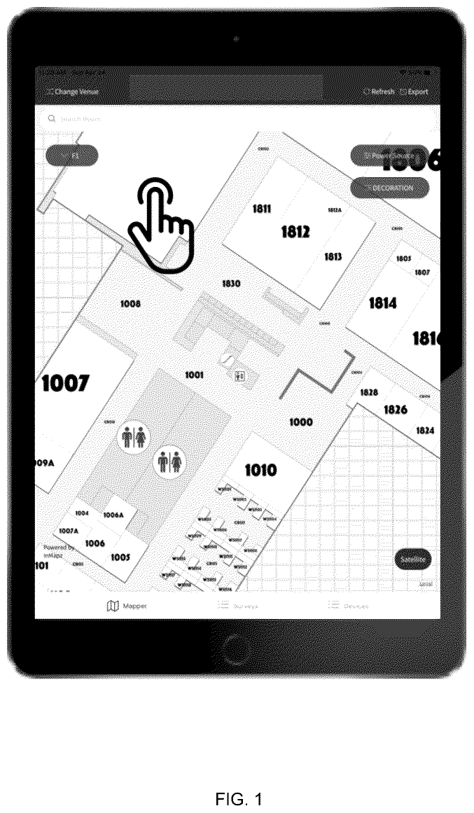

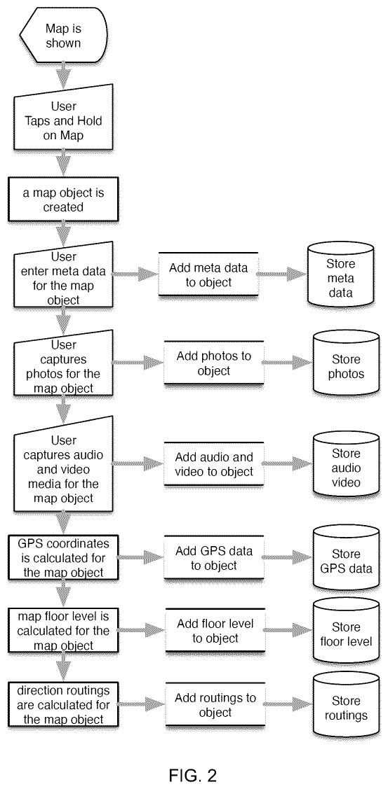

As shown in FIG. 1, a portable tablet having hardware, software, firmware, and electronic information may be used. A portion of a map is shown, with a pointed finger indicating that the map is interactive via touch. FIG. 2 shows a flow chart of an exemplary embodiment of the invention

The following provides examples of how the invention may be used. The processes associated with these examples are generally depicted in FIG. 2

### Example 1

A user opens an application via tapping on an icon on an interactive display of a smart mobile device to view digital maps of a property having a building thereon. The user is on site and sees where the user is standing. The user walks up to the location of an item. Then, the user taps and holds on the digital maps.

Through touch, the user marks the location of device where the touch point is on the map. As a result, the marked location is recorded on the map, e.g., as a marked point.

Once recorded, the GPS coordinates of the marked location is associated to the marked point. The floor level of the building at the marked location is associated to the marked point.

The location is specified by GPS latitude, longitude, and floor elevation. If the location is located outdoors or outside, then the floor elevation is considered is the ground floor. Calculation of the location is performed when the location is marked.

Then, navigation routings to the marked location are calculated and are associated to the marked point. The user takes photos of the marked item. Photos are associated with the marked location.

Optionally, the user also takes videos of the marked item. Videos are associated with the marked location.

Then, the user makes audio recordings of the marked item. Audios are associated with the marked location.

Later, the user enters text info about the marked item. Texts are associated with the marked location.

### Example 2

A user opens user opens a web browser to view digital maps. The user clicks on web-based maps. Then, the user marks the location of device where the clicked point is on the map. The marked location is recorded on the map. Then, GPS coordinates of the marked location is associated to the marked point. The floor level of the building at the marked location is associated to the marked point. Navigation routings to the marked location are calculated and are associated to the marked point.

The user uploads photos of the marked item. Photos are associated with the marked location. Then, the user records and upload audio recordings of the item. The recordings are associated with the marked location.

Then, videos of the marked item are uploaded. The videos are associated with the marked location.

Finally, the user enters text info about the marked item. The text may involve information pertaining to the height or elevation of the marked item relative to a reference point/level. Texts are associated with the marked.

Optionally the user or someone else may polish the integrated information associated with the interactive map to render the invention more user friendly.

Variations of the invention are possible for example, listed actions as disclosed above do not have to be performed in any particular order unless such order lends to ease of use or user friendliness. In addition, the invention may be personalized to the user's preference of language and the like. In addition, GPS routing coordinates may be translated to directions using English and/or metric units as measures of distance, e.g., in feet or meters. In rare cases, units such as inches, centimeters, kilometers and/or miles may be used. Such units may be estimates or actual measured distances.

Similarly, the power source of the smart devices may vary as well. In some instances, nominally alkaline aqueous batteries and or lithium metal batteries of an appropriate voltage, e.g., of approximately 1.4 to approximately 1.7 volts may be used. In addition, batteries and/or packs thereof having nominal open circuit voltages of approximately 3.6 volts to approximately 4.1 volts may be employed in conjunction with the invention. Battery type selection typically involves an appropriate choice of power and/or energy density of desired performance associated with the battery type.

Similarly, the invention may employ an electronic technique wherein a marked location has GPS information (latitude, longitude, floor level, path routing). The location may be associated with an object. The object may have meta data (text descriptions, photos, audio, videos).

In other words, at least two tasks may be occurring happening behind the scene when a user marks a location. The location and its properties are created. In addition, the object is created and its associated data are entered.

All patents and/or publications cited herein are hereby incorporated by reference to an extent not inconsistent to the above disclosure.

What is claimed is:

1. A method for marking and recording a location of an item on a digital interactive map, comprising:
(a) providing the digital interactive map on a portable electronic device with a touch-sensitive display;
(b) displaying the digital interactive map on a web browser as presented on the touch sensitive display and/or some other display; and
(c) allowing a user to enter the location of the item by a point of contact for a finite amount of time on the digital interactive map,
thereby recording the item and the location on the digital interactive map.

2. The method of claim 1, wherein GPS coordinates of the location is recorded.

3. The method of claim 2, wherein the location of the item is located in a building, and the method allows for recordation of whether the location is indoor.

4. The method of claim 1, further comprising calculating a path to the location of the item.

5. The method of claim 1, further comprising attaching photos to the location on the map.

6. The method of claim 1, further comprising attaching an audio recording to the location on the map.

7. The method of claim 1, further comprising attaching a video recording to the location on the map.

8. The method of claim 1, carried out with ease by a user with little or no training technical training.

9. A system for moving a location of a representation of a real item on a three-dimensional electronic digital interactive map, comprising:
the digital interactive map provided on a touch sensitive device display having the real item represented at a location on the map;
a display means for displaying the digital interactive map as a web browser or mobile application as presented on the touch sensitive display; and
means that allow user to change the location of the item by a point of contact through touch of the display for a finite amount of time on the digital interactive map,
thereby allowing for optionally substantially instantaneous updating of a changed location of the item's representation on the digital interactive map.

10. The system of claim 9, further comprising a means for calculating or recalculating a path to find the changed location.

11. A device for providing to a user a navigation path to a representation of a real item relative to a building on a digital interactive map, comprising:
a web-based or a nonweb-based digital interactive map provided as hardware and optional software in a handheld device that has touch sensitive display,
wherein the map contains the representation of the real item at a location on the map, and the map contains information regarding a building's layout;
a means for locating the user relative the representation of the item on the map; and
a means for drawing a navigation path for the user on the digital interactive map to the item relative to a layout of the building.

12. The device of claim 11, comprising a means for calculating GPS coordinates of a drawn navigational path on the map.

13. The device of claim 12, wherein the navigational path is displayed in feet or inches.

14. The device of claim 12, wherein the navigational path is displayed in metric units.

15. The device of claim 12, operable both indoors and outdoors.

16. The device of claim 12, electronically communicating a smart sensor.

17. The device of claim 12, capable of showing ground level associated with the building.

18. The device of claim 12, having a display with a touch sensitive icon relating to a decoration, power source, a venue or venue change, refresh, and/or export functionality.
